(19) United States
(12) Patent Application Publication
(10) Pub. No.: US 2014/0299292 A1
(43) Pub. Date: Oct. 9, 2014

(54) Air Conditioning System For Motor Vehicles And Heat Exchangers

(71) Applicants: Albert Gwosdek, Hablach (DE); Wolfgang Hopf, Stockheim (DE)

(72) Inventors: Albert Gwosdek, Hablach (DE); Wolfgang Hopf, Stockheim (DE)

(73) Assignee: Valeo Systems Thermiques, Le Mesnil Saint Denis (FR)

(21) Appl. No.: 14/343,898

(22) PCT Filed: Sep. 11, 2012
(86) PCT No.: PCT/EP2012/003807

§ 371 Date: Jun. 4, 2014

(30) Foreign Application Priority Data
Sep. 12, 2011 (DE) 20 2011 105 751.1

(51) Int. Cl. B60H 1/00

(52) U.S. Cl. CPC B60H 1/00007
USPC 165/59

(57) ABSTRACT

The invention concerns the air conditioning system (12) for motor vehicles, having a vehicle air conditioning device (14) which comprises a first heat exchanger (18) for heating air in the passenger compartment of the vehicle, and a stationary-mode air conditioning device (16) which comprises a second heat exchanger (20) for cooling air in the passenger compartment of the vehicle, wherein the first and second heat exchangers (18, 20) each have distributor systems (30) and a multiplicity of ducts (34), arranged in parallel, for a refrigerant or coolant as well as laminations (36) for transferring heat to air, characterized in that the distributor systems (30), ducts (34) and laminations (36) of the two heat exchangers (18, 20) have the same geometry.

The invention relates to an air conditioning system for motor vehicles, having a vehicle air conditioning device which comprises a first heat exchanger for heating air in the passenger compartment of the vehicle, and a stationary-mode air conditioning device which comprises a second heat exchanger for cooling air in the passenger compartment of the vehicle, wherein the first and second heat exchangers each have distributor systems and a multiplicity of ducts, preferably arranged in parallel, for a refrigerant or coolant as well as laminations for transferring heat to air.

Air conditioning systems of this type are known, in particular, for lorries, wherein the stationary-mode air conditioning device is suitable, in particular, for cooling the passenger compartment of the vehicle during breaks from travel. Since the two heat exchangers for heating and respectively cooling have to satisfy different requirements, for example as a result of humidity in the air, which condenses when air cools, these heat exchangers have different designs. While the heat exchanger for the vehicle air conditioning device can be manufactured in large numbers, and therefore cost-effectively, only small numbers are usually required for use in stationary-mode air conditioning devices.

The purpose of the invention is to be able to manufacture an air conditioning system of the generic type in a cost-effective way.

This object is achieved in an air conditioning system of the type mentioned at the beginning by virtue of the fact that the distributor systems, ducts and laminations of the two heat exchangers have the same geometry. This enables the components of both the first and the second heat exchanger to be manufactured in large numbers, as a result of which the manufacturing costs can be reduced.

A particularly compact design of the two heat exchangers is made possible if the two heat exchangers are embodied as high-power heat exchangers, wherein the distance between the ducts is preferably between 6 and 9 mm, the duct width is between 1.8 and 0.8 mm and/or the distance between the laminations is between 1.3 and 0.8 mm. The compact design of the heat exchangers which is made possible in this way permits a saving in terms of the construction space both in the region of the vehicle air conditioning device and in that of the stationary-mode air conditioning device.

Flowing-off of condensate in the cooling mode of the heat exchanger can be made possible by virtue of the fact that the laminations have breakthroughs which permit fluid to flow perpendicularly with respect to the plane of the lamination, wherein the breakthroughs are preferably formed by obliquely positioned wall sections. By means of the obliquely positioned wall sections, air flowing through the heat exchanger can be deflected, as a result of which the air path through the heat exchanger is made longer, permitting better transfer of heat.

A compact design of the vehicle air conditioning device, for example in the region of the dashboard, can be achieved by arranging the air through-flow plane of the first heat exchanger substantially horizontally, preferably at an angle of up to 15° with respect to the horizontal.

Flowing-off of condensate of the second heat exchanger is improved in that the air through-flow plane of the second heat exchanger is arranged substantially vertically, preferably at an angle of 15° with respect to the vertical.

In order to protect the heat exchanger against damage by condensed fluid, at least the second heat exchanger can have an anti-corrosion coating and/or a hydrophilic coating. A PU silicate coating is preferably provided.

For example, the stationary-mode air conditioning device can have a cold accumulator which is connected to the second heat exchanger by a coolant circuit. In this way, a single coolant circuit is sufficient to operate the stationary-mode air conditioning device. The cold accumulator and the second heat exchanger can be arranged in a spatially separated fashion on the vehicle.

The vehicle air conditioning device preferably permits the cold accumulator to be cooled in order to charge the cold accumulator. No separate charging device is therefore required for charging the cold accumulator.

In the embodiment which is optimized in a cost-effective fashion, the two heat exchangers are of identical design, at most with the exception of a coating on the second heat exchanger, with the result that all the individual parts and geometries are identical.

The object of the invention is also achieved by a heat exchanger for an air conditioning system described above, wherein the heat exchanger comprises a distributor system and a multiplicity of ducts, arranged in parallel, for a refrigerant or coolant, as well as laminations for transferring heat to air. The distance between the ducts is between 6 and 9 mm, the duct width is between 1.8 and 0.8 mm and/or the distance between the laminations is between 1.3 and 0.8 mm. The laminations have breakthroughs which permit fluid to flow perpendicularly with respect to the planes of the laminations, wherein the breakthroughs are preferably formed by obliquely positioned wall sections.

Further features and advantages of the invention can be found in the following description and in the drawings, to which reference is made:

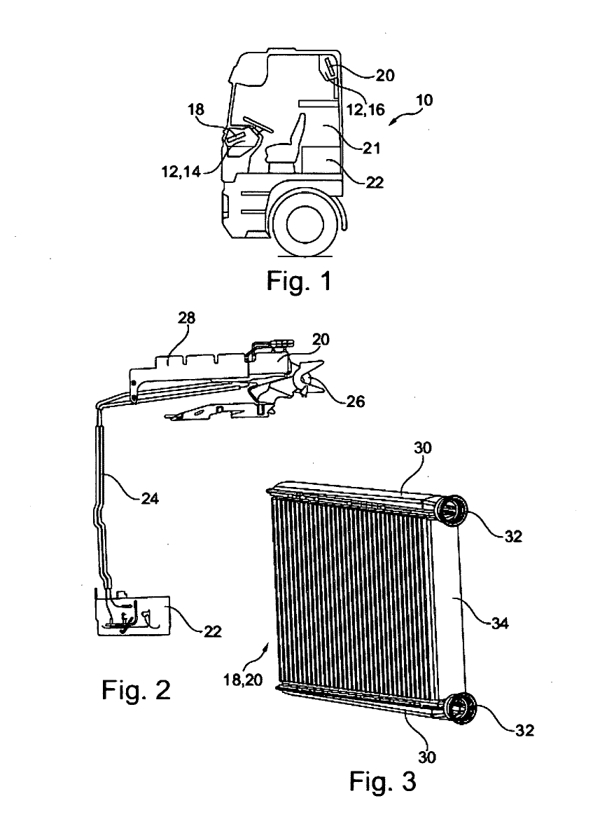

FIG. 1 shows a schematic view of a driver's cab of a vehicle having an air conditioning system according to the invention;

FIG. 2 shows a stationary-mode air conditioning device of an air conditioning system according to the invention;

FIG. 3 shows a perspective view of a heat exchanger according to the invention;

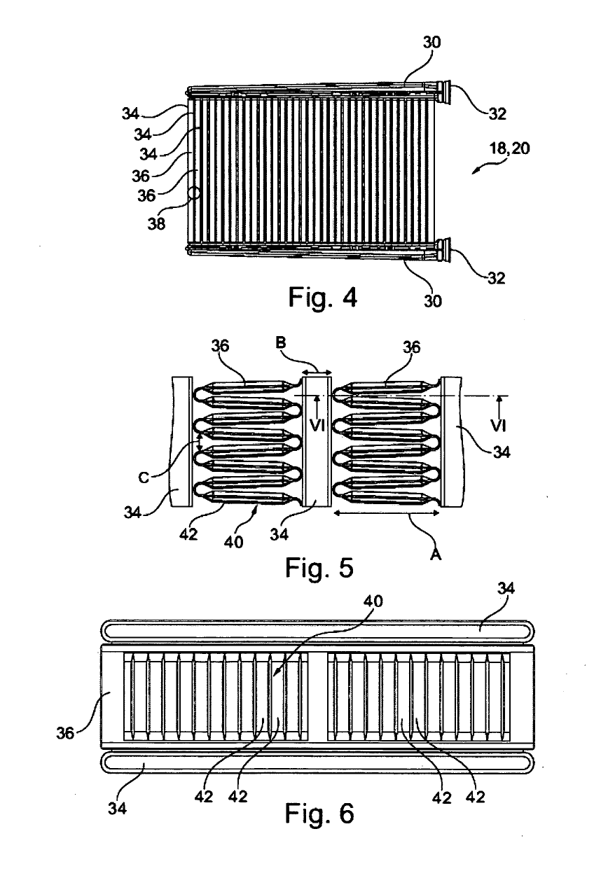

FIG. 4 shows a front view of the air through-flow plane of the heat exchanger according to FIG. 3;

FIG. 5 shows a view of the detail of the heat exchanger according to FIG. 4;

FIG. 6 shows a view of the detail of a lamination of the heat exchanger according to FIG. 3;

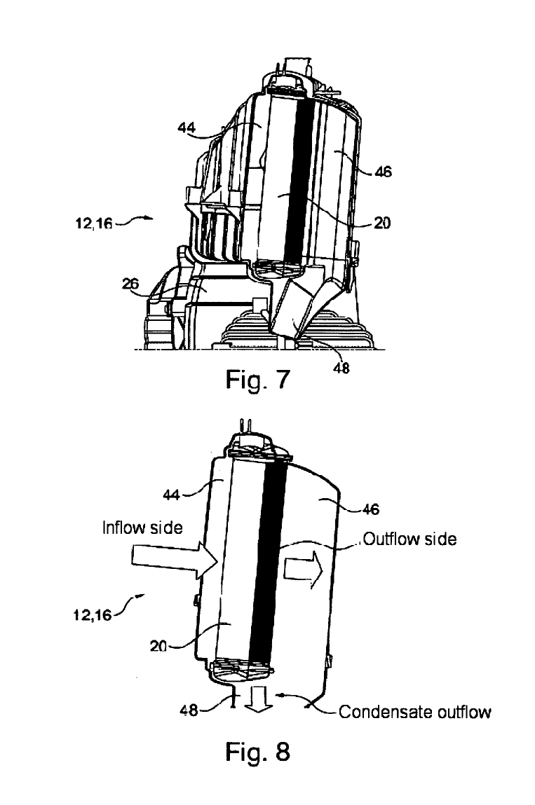

FIG. 7 shows a view of the detail of the stationary-mode air conditioning device according to FIG. 2;

FIG. 8 shows a view of the detail of the stationary-mode air conditioning device according to FIG. 2; and

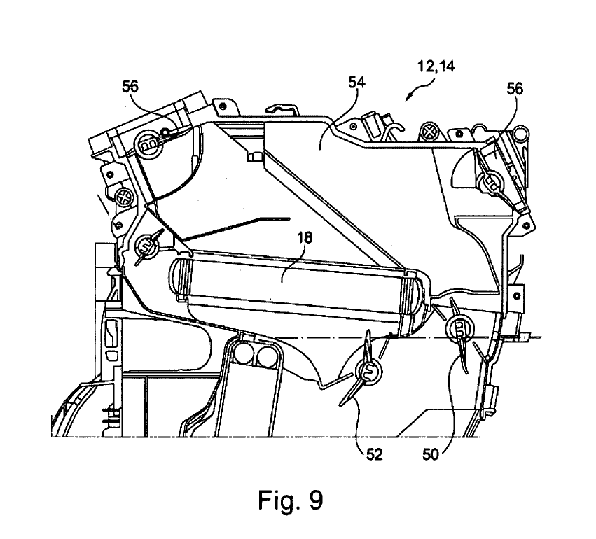

FIG. 9 shows a view of the detail of a vehicle air conditioning device of an air conditioning system according to FIG. 1.

FIG. 1 shows a driver's cab 10 of a lorry having an air conditioning system 12. The air conditioning system 12 comprises a vehicle air conditioning device 14 which is provided in the region of the dashboard, and a stationary-mode air conditioning device 16 which is arranged in the rear region of the driver's cab 10.

The vehicle air conditioning device 14 comprises a first heat exchanger 18 for heating air in the passenger compartment of the vehicle, and the stationary-mode air conditioning device 16 comprises a second heat exchanger 20 for cooling air in the passenger compartment of the vehicle, in particular in the region of the sleeping surface or the rest area 21.

The stationary-mode air conditioning device 16 also comprises a cold accumulator 22, which is connected to the second heat exchanger 20 by a coolant circuit 24 (see FIG. 2). The cold accumulator 22 is arranged in the lower region of the driver's cab 10. The spatial separation of the cold accumulator 22 from the heat exchanger 20 of the stationary-mode air conditioning device 16 permits a space-saving arrangement of the stationary-mode air conditioning device 16 in the driver's cab 10.

Optimal cooling of air by the stationary-mode air conditioning device 16 is made possible by virtue of the fact that the heat exchanger 20 of the stationary-mode air conditioning device 16 and the associated ventilation system are arranged in the upper region of the driver's cab 10. Good use of the space of the passenger compartment of the vehicle is therefore made possible. In the embodiment shown, two sleeping surfaces are provided in the driver's cab 10, on which sleeping surfaces the driver and the front passenger can rest during breaks in journeys. The stationary-mode air conditioning device 16 permits the passenger compartment of the vehicle to cool during such breaks in journeys without the vehicle engine being operated, by utilizing the cold accumulator.

Alternatively, it is, of course, also possible to provide an electric accumulator which stores electrical energy and by means of which the air conditioning device and the compressor thereof are operated in the parked mode.

FIG. 2 shows a view of the detail of the stationary-mode air conditioning device 16. A coolant circuit 24 connects the cold accumulator 22 to the heat exchanger 20 of the stationary-mode air conditioning device 16. A pump for circulating the coolant in the coolant circuit 24 can be provided either at the cold accumulator 22 or the heat exchanger 20.

The stationary-mode air conditioning device 16 also comprises a blower 26 and an air conductance system 28, which permit the driver's cab 10 to be ventilated with cooled air.

The heat exchanger 18 of the vehicle air conditioning device 14 and the heat exchanger 20 of the stationary-mode air conditioning device 16 are of structurally identical design and will be described below with reference to FIGS. 3 to 6.

FIG. 3 shows a perspective view of the heat exchanger or 20. The heat exchanger 18, 20 comprises two distributor systems 30, each with a connection 32 to the coolant circuit 24. The distributor systems 30 permit the coolant or refrigerant to be distributed and collected through a multiplicity of ducts 34 which are arranged in parallel. Laminations 36 for transferring heat to air are provided between the ducts 34 which are arranged in parallel.

FIG. 4 shows a plan view of the air through-flow plane of the heat exchanger 18. 20. The section from heat exchanger 18, 20 which is characterized by the circuit 38 in FIG. 4 is shown in a sectional view in FIG. 5. Three ducts 34 which are arranged in parallel with one another are each formed by flat tubes, through which refrigerant or coolant can flow. Laminations 36 are arranged between the ducts 34. The laminations 36 are connected in a thermally conductive fashion to the ducts 34 and form a large surface for transferring heat between the laminations 36 and the air flowing through them.

The heat exchanger 18, 20 is embodied in a compact fashion as a high-performance heat exchanger, wherein the distance between the ducts A is between 6 and 9 mm, the channel width B is between 1.8 and 0.8 mm and the distance C between the laminations is between 1.3 and 0.8 mm. In this way, a very large surface for the exchange of heat with air is made available, while the heat exchanger 18, 20 is of only a small size.

If the heat exchanger is used to cool air, in particular in its use as the second heat exchanger 20 in the stationary-mode air conditioning device 16, humidity in the air can condense on the laminations 36. Flowing-off of condensed humidity from the air on the laminations 36 is assisted by virtue of the fact that the laminations 36 have breakthroughs 40 which permit fluid to flow perpendicularly with respect to the plane of the lamination 36, wherein the breakthroughs 40 are formed by the obliquely positioned wall sections 42 (see FIG. 6).

Furthermore, the obliquely positioned wall sections 42 bring about a deflection of the air flowing through the heat exchanger 18, 20. In this way, the transfer of heat within the heat exchanger 18, 20 is improved.

As can be seen in FIG. 5, first wall sections 42 are provided which are positioned obliquely in the upward direction, as well as second wall sections 42 which are positioned obliquely in the downward direction.

FIG. 6 shows a section perpendicular with respect to the air through-flow plane of the heat exchanger 18, 20 along the sectional plane VI-VI (FIG. 5). Two adjacent ducts 34, which are arranged in parallel, as well as a lamination 36 which is arranged between the two ducts 34 are illustrated. In the embodiment shown, the lamination on the left-hand and right-hand sides has in each case a set of obliquely positioned wall sections 42, which form the breakthroughs 40. In the embodiment shown, one set of the wall sections 42 is positioned obliquely in the upward direction, while the other set of wall sections 42 is positioned obliquely in the downward direction.

At least the second heat exchanger 20 has an anti-corrosion coating and/or a hydrophilic coating. In the preferred embodiment, a PU silicate coating is provided. A hydrophilic coating facilitates the flowing-off of the condensed humidity from the air. In particular, the heat exchangers 18, 20 differ only in the coating which is provided on the heat exchanger 20.

FIGS. 7 and 8 show the second heat exchanger 20 and its arrangement in the stationary-mode air conditioning device 16. The housing in the stationary-mode air conditioning device 16 comprises an air supply duct 44, an air discharge duct 46 and a condensate outflow 48.

The air through-flow plane of the second heat exchanger 20 is arranged substantially vertically, in particular at an angle of up to 15° with respect to vertical. By this arrangement, the flowing-off of condensed humidity from the air is facilitated. The vertical arrangement of the second heat exchanger in the stationary-mode air conditioning device 16 can also optimize the required installation space, and the available space in the driver's cab 10 can be used better.

FIG. 9 shows a section of the vehicle air conditioning device 14 with the first heat exchanger 18 for heating air in the passenger compartment of the vehicle. The heat exchanger 18 is arranged substantially horizontally, in particular at an angle of up to 15° with respect to horizontal. In this way it is possible to embody the vehicle air conditioning device 14 in such a way that it requires only a small installation height and can therefore easily be arranged in the region of the dashboard in the driver's cab 10.

Air flowing through the vehicle air conditioning device is divided into a cold air stream and a warm air stream via a cold air flap 50 and a warm air flap 52, wherein the warm air stream flows through the first heat exchanger 18, and is heated in the process. Warm air stream and cold air stream are mixed in a mixing and distribution chamber 54 and directed to various outflow openings 56 which are fed to various vehicle regions, for example the windscreen, the dashboard or the foot well.

In the embodiment shown, the two heat exchangers 18, 20 are each of identical design. It is however also possible to provide that the two heat exchangers 18, 20 differ slightly through a coating of the heat exchanger.

By virtue of the fact that distributor systems 30, ducts 34 and laminations 36 of the two heat exchangers 18, 20 have the same geometry, these components can be manufactured cost-effectively in large series-produced numbers, as a result of which the first heat exchanger for the vehicle air conditioning device 14 and the second heat exchanger 20 for the stationary-mode air conditioning device 16 can be manufactured cost-effectively.

In the embodiment shown, the heat exchangers 18, 20 are embodied as compact high-performance heat exchangers which are suitable both for heating and for cooling air.

1. An air conditioning system (12) for motor vehicles, having:
a vehicle air conditioning device (14) which comprises a first heat exchanger (18) for heating air in the passenger compartment of the vehicle, and
a stationary-mode air conditioning device (16) which comprises a second heat exchanger (20) for cooling air in the passenger compartment of the vehicle,
wherein the first and second heat exchangers (18, 20) each have distributor systems (30) and a multiplicity of ducts (34), arranged in parallel, for a refrigerant or coolant as well as laminations (36) for transferring heat to air, and
wherein the distributor systems (30), ducts (34) and laminations (36) of the two heat exchangers (18, 20) have the same geometry.

2. An air conditioning system according to claim 1, wherein the two heat exchangers (18, 20) are embodied as high-power heat exchangers and wherein the distance (A) between the ducts (34) is preferably between 6 and 9 mm, the duct width (B) is between 1.8 and 0.8 mm and/or the distance (C) between the laminations is between 1.3 and 0.8 mm.

3. An air conditioning system according to claim 1, wherein the laminations (36) have breakthroughs (40) which permit fluid to flow perpendicularly with respect to a plane of the lamination (36) and wherein the breakthroughs (40) are preferably formed by obliquely positioned wall sections (42).

4. An air conditioning system according to claim 1, comprising an air through-flow plane of the first heat exchanger (18) arranged substantially horizontally, at an angle of up to 15° with respect to horizontal.

5. An air conditioning system according to claim 1, wherein an air through-flow plane of the second heat exchanger (20) arranged substantially vertically, at an angle of up to 15° with respect to vertical.

6. An air conditioning system according to claim 1, wherein at least the second heat exchanger (20) has an anti-corrosion coating and/or a hydrophilic coating.

7. An air conditioning system according to claim 1, wherein the stationary-mode air conditioning device (16) has a cold accumulator (22) which is connected to the second heat exchanger (20) by a coolant circuit (24).

8. An air conditioning system according to claim 7, wherein the vehicle air conditioning device (14) permits the cold accumulator (22) to be cooled in order to charge the cold accumulator (22).

9. An air conditioning system according to claim 1, wherein the two heat exchangers (18, 20) are of identical design except for a coating on the second heat exchanger (20).

10. A heat exchanger (18, 20) for an air conditioning system (12) according to claim 1, having distributor systems (30) and a multiplicity of ducts (34), arranged in parallel, for a refrigerant or coolant, as well as laminations (36) for transferring heat to air, wherein a distance (A) between the ducts (34) is between 6 and 9 mm, a duct width (B) is between 1.8 and 0.8 mm and/or a distance (C) between the laminations is between 1.3 and 0.8 mm, and wherein the laminations (36) have breakthroughs (40) which permit fluid to flow perpendicularly with respect to a planes of the laminations (36), wherein the breakthroughs (40) are preferably formed by obliquely positioned wall sections (42).

11. An air conditioning system according to claim 2, wherein the laminations (36) have breakthroughs (40) which permit fluid to flow perpendicularly with respect to a plane of the lamination (36) and wherein the breakthroughs (40) are preferably formed by obliquely positioned wall sections (42).

12. An air conditioning system according to claim 3, comprising an air through-flow plane of the first heat exchanger (18) arranged substantially horizontally, at an angle of up to 15° with respect to horizontal.

13. An air conditioning system according to claim 4, wherein an air through-flow plane of the second heat exchanger (20) arranged substantially vertically, at an angle of up to 15° with respect to vertical.

14. An air conditioning system according to claim 2, wherein the stationary-mode air conditioning device (16) has a cold accumulator (22) which is connected to the second heat exchanger (20) by a coolant circuit (24).

15. An air conditioning system according to claim 3, wherein the stationary-mode air conditioning device (16) has a cold accumulator (22) which is connected to the second heat exchanger (20) by a coolant circuit (24).
